(19) United States
(12) Patent Application Publication
(10) Pub. No.: US 2008/0088321 A1
(43) Pub. Date: Apr. 17, 2008

(54) Ice measurement

(75) Inventors: Yi Zheng, Cold Spring, MN (US); Ulrich Fink, Maple Grove, MN (US); Umer A. Qureshi, Burnsville, MN (US)

Correspondence Address: PYLE & PIONTEK LLC, 221 N. LASALLE STREET, SUITE 2036, CHICAGO, IL, 60601, US

(73) Assignee: IMI Vision Limited

(21) Appl. No.: 11/974,549

(22) Filed: Oct. 15, 2007

(30) Foreign Application Priority Data
Oct. 17, 2006 (GB) 0620544.7

(51) Int. Cl. G01N 27/22

(52) U.S. Cl. 324/667; 324/664; 324/670

(57) ABSTRACT

A method and apparatus are provided for directly measuring the ice fraction in an ice slurry. Spaced electrodes measure the electrical property of the slurry, such as capacitance across the electrodes, or alternatively conductance or other electrical characteristics. That signal is then translated into an ice fraction by a microprocessor or controller.

This invention relates to the measurement of the ice content of ice slurries.

### BACKGROUND OF THE INVENTION

Ice slurries, which are a suspension of small ice crystals in a liquid are used in a number of different applications. One common application of ice slurries is as a replacement for more traditional fluids, for example liquid glycol solutions, in cooling systems. In such applications they have the added benefit that the ice acts as a thermal reserve and they maintain a substantially constant temperature as they are pumped around the system, thereby being able to deliver the same cooling throughout the system. Another application of ice slurries is for use in frozen beverage products.

In both of these applications it is useful to know the percentage ice content of the mixture, i.e. the “ice fraction”. Usually this is used to feedback to the control of the whole system to control a part of it. For example, if in a cooling system the ice has all melted by the time the fluid returns at the end of the circuit then some parts of the system might not be receiving the cooling they require. Therefore the system may want to increase the speed at which the slurry is pumped until such a time as there is a small amount of ice in the returning fluid, thereby guaranteeing that all points in the cooling circuit are getting cooled to the same degree.

In the beverage application the ice fraction of an ice slurry will affect the texture and thickness of the drink. Therefore controlling ice content should allow a more consistent product.

Currently there are a number of methods of controlling the ice fraction of an ice slurry. In cooling systems these are typically by measuring and controlling the temperature and in beverage systems the ice content is roughly controlled by determining the viscosity of the ice slurry. However, neither of these solutions is reliable in giving an accurate measurement of the ice fraction of the ice slurry.

Taking viscosity, the viscosity of an ice slurry is partially dependent on the ice fraction, but there are a number of other factors which influence it. One in particular is the maturing of the ice crystals over time. Over time ice crystals in a slurry tend to agglomerate and form larger crystals. The size and the shape of the ice crystals in the slurry have a large effect on the viscosity and as such viscosity is not a reliable method of measuring ice fraction.

Temperature can be used to measure ice fraction but again is not a reliable method. The fraction at a particular temperature is dependent on other factors such as concentration so if the concentration of a system may change, for example if a person fills a system with a different concentration of glycol solution to be frozen then the ice fraction readings will not be accurate. Also, even with known concentrations, the change of ice fraction with temperature is not great and as such the resolution of this method is not very good.

### SUMMARY OF THE INVENTION

It is the object of the present invention to provide a method of, and a sensor for, directly measuring the ice fraction of an ice slurry.

According to a first aspect of the invention there is provided a method of measuring the ice fraction of an ice slurry comprising the steps of:

a) establishing in the slurry first and second, mutually spaced electrodes;

b) connecting the electrodes into an electrical circuit adapted to sense, across the electrodes, the magnitude of an electrical property of the slurry that varies with the ice fraction thereof, said circuit being adapted to generate an output signal indicative, in response to the sensed magnitude of said electrical property, of the ice fraction of the slurry; and

c) energising the electric circuit, whereby said output signal is generated. In a preferred method the electrical circuit is operable to measure the capacitance across the electrodes. In this method at least one of said first and second electrodes is electrically insulated from the ice slurry and the measured signal is purely dependant on the capacitance across the two electrodes.

In an alternative method said first and second electrodes are in electrical contact with the ice slurry and the measured signal is dependant on both the capacitance and the conductivity across the two electrodes. Preferably in this method the electrical circuit is operable to measure the impedance across the electrodes.

Preferably the method further comprises comparing the output signal to a first look up table containing data relating the output signal to the percentage ice fraction of the slurry. The data in the look up table is derived from empirically gathered data correlating the measured signal to ice fraction. Alternatively the method comprises performing a predictive algorithm on the output signal to calculate the percentage ice fraction of the slurry. The algorithm is derived from empirically gathered data correlating measured signal to ice fraction.

In a preferred method, the electronic circuit comprises a resistive-capacitive (RC) oscillator, said first and second electrodes forming the capacitor of said resistive-capacitive (RC) oscillator such that the change in capacitance across the electrodes due to the change in ice fraction of the slurry between the electrodes changes the frequency of the output of the oscillator. In an alternative preferred method the electrodes and the ice slurry therebetween form a variable resistor of an RC oscillator such that the change in conductivity due to the change in ice fraction of the slurry between the electrodes changes the frequency of the output of the oscillator.

Preferably the RC oscillator is an RC Schmitt-Trigger oscillator which produces a square-wave output. Alternatively other types of oscillators may be used, as may other wave forms.

In the preferred method, where the electrodes replace the capacitor of the RC oscillator, the resistor of the RC oscillator is selected to give an output frequency from the oscillator from 0.5 to 30 MHz when the ice fraction of the slurry is zero. More preferably, the resistor is selected to give an output frequency from 0.8 to 1.2 MHz. Preferably, in an arrangement where the electrodes replace the resistor of the RC oscillator, the capacitor of the RC oscillator is selected to give an output frequency from the oscillator from 0.8 to 10 MHz.

In an alternative arrangement an impedance analyzer is used do measure the impedance of the circuit, preferably the impedance analyzer is part number AD8302 from Analogue Devices. Preferably the impedance analyzer measures the amplitude and the phase of the complex impedance. More preferably the electronics associated with the impedance analyzer calculate the reactance X, or conductivity R, by performing either of the following the algorithms:

X=A sin Ø or R=A cos Ø

where A=amplitude and Ø=phase, both measured by the impedance analyzer.

Preferably the calculated value of X, or R, is compared to a first look up table containing data correlating X, or R, to the percentage ice fraction of the slurry. The data in the look up table is derived from empirically gathered data correlating the measured signal to ice fraction. Alternatively the method comprises performing a predictive algorithm on the output signal to calculate the percentage ice fraction of the slurry. The algorithm is derived from empirically gathered data correlating measured signal to ice fraction.

Preferably, during the initial creation of the slurry, the method further comprises the steps of:

monitoring the temperature of the liquid as it cools,

identifying the temperature at which ice formation starts; and

using this temperature to generate an offset to compensate for effects of liquid concentration.

Apart from being dependent on the percentage ice fraction, the capacitance and the conductivity of a liquid are dependent on some external factors, notably the temperature (most significant prior to nucleation of ice within the liquid) and any impurities in the liquid. Often when making an ice slurry it is preferable to use a solution with a freezing point below zero and this is typically achieved by adding a substance such as glycol, a sugar or a salt to the liquid. The concentration of these (or other) substances affects the capacitance and the conductivity of the ice slurry. However, the effect of impurities in the solution does not appear to change the characteristic of the relationship between the ice fraction and the electrical property, merely it shifts the curve correlating the output signal of the electrical circuit to ice fraction on the ice fraction axis. Therefore by knowing the capacitance immediately prior to ice nucleation the offset can be calculated and either the frequency can be adjusted prior to correlating it to ice fraction in the lookup table, or alternatively the ice fraction read from the look up table can be adjusted by the offset to compensate for the impurities in the liquid. The point at which ice formation starts is determined by looking at the temperature change over time. Starting from a warm liquid, as it is cooled the temperature drops until it falls below its freezing point. The liquid is then super-cooled. At the point at which ice nucleation initiates the liquid will warm slightly (but is still below its freezing point) and then remains relatively constant but with a slight downward trend and ice formation continues. The slight decrease in temperature is due to the decreasing freezing point of the liquid due to the remaining solution becoming more concentrated as the ice freezes out of it. By monitoring the temperature as the solution is cooled the point at which the curve changes direction from super-cooled to ice formation can be determined and the frequency at that point recorded. Preferably this is then correlated to a lookup table to determine the offset for the frequency/ice fraction look up table to compensate for differences in concentration of the solution being frozen.

According to a second aspect of the invention there is a provided method of controlling an ice slurry generator having a cooling circuit comprising the steps of: sensing if the ice fraction rises above or falls below respective set points by measuring the output frequency of an RC oscillator, the capacitor of which comprises two electrodes separated, in use, by a liquid or an ice slurry;

when the output frequency of the oscillator rises above a set value, turning the cooling circuit off; and
when the output frequency of the oscillator falls below a set value turning the cooling circuit on.

According to a third aspect of the present invention there is provided a method of controlling an ice slurry generator having a cooling circuit comprising the steps of: sensing if the ice fraction rises above or falls below respective set points by measuring the output frequency of an RC oscillator, the resistor of which comprises two electrodes which in use are in contact with, and separated by, a liquid or an ice slurry;

when the output frequency of the oscillator rises above a set value, turning the cooling circuit off; and
when the output frequency of the oscillator falls below a set value turning the cooling circuit on.

According to a fourth aspect of the present invention there is provided an ice slurry sensor comprising an RC oscillator, the capacitor or the resistor of which comprises two electrodes separated, in use, by a liquid or a liquid/ice mixture, configured to output an oscillating signal having a frequency indicative of the ice fraction of the liquid/ice mixture.

Preferably the sensor further comprises a look up table for correlating the output frequency of the oscillator to the ice fraction of the liquid/ice mixture.

In a preferred embodiment the sensor further comprises an electronic controller for generating an output signal indicative of the ice fraction of the liquid/ice mixture. Preferably the electronic controller comprises programmable logic controller, a programmable integrated circuit or a microcontroller with associated memory means for holding data correlating the frequency of the oscillator to the ice fraction of the liquid/ice mixture.

Preferably the sensor further comprises a divider to reduce the frequency of the RC oscillator output to a frequency easily used by the electronic controller. More preferably the output of the divider is between 1 KHz and 100 KHz.

In a preferred arrangement the sensor further comprises a temperature sensor for detecting the temperature of the ice slurry. Preferably the electronic controller detects the minimum super-cooled temperature and correlates the detected minimum super-cooled temperature to an offset value to offset one of the frequency and its correlated ice fraction.

According to a fifth aspect of the invention there is provided an ice slurry sensor comprising an sinusoidal signal generator connected to a circuit including a pair of electrodes separated, in use, by a liquid or a liquid/ice mixture, an impedance detector to measure the amplitude and phase of the impedance in the circuit and a signal processor means said signal processor means adapted for receiving the output from said impedance detector and create a signal indicative of the ice fraction of the liquid or liquid/ice mixture.

Preferably impedance detector outputs signals indicative of the amplitude and phase of the complex impedance and the signal processor means performs an algorithm on the impedance detector output signals to calculate either the reactance or conductivity of the slurry. Preferably the signal processor means further comprises a look up table for correlating either the calculated conductivity or the calculated reactance to the ice fraction of the liquid/ice mixture.

In a preferred embodiment the sensor further comprises a signal processor means for generating an output signal indicative of the ice fraction of the liquid/ice mixture. Preferably the signal processor means comprises programmable logic controller, a programmable integrated circuit or a microcontroller with associated memory means for holding data correlating the calculated conductivity or the reactance to the ice fraction of the liquid/ice mixture.

In one arrangement the sinusoidal signal generator generates a signal having a frequency of less that 1 MHz and the conductivity is calculated to measure the ice fraction.

In an alternative arrangement the sinusoidal signal generator generates a signal having a frequency of greater that 25 MHz and the reactance is calculated to measure the ice fraction.

Preferably the sinusoidal signal generator can create a low frequency signal (<1 MHz) and a high frequency signal (>25 MHz). Preferably when the fluid being measured is in its fully liquid state the signal generator creates a low frequency signal, the conductivity R is calculated at a known temperature, and that value is correlated to a look up table to determine the concentration of an antifreeze substance within the fluid. Preferably when the fluid being measured is partially frozen, i.e. it is an ice/liquid mix, the signal generator creates a high frequency signal, the reactance X is calculated, and that value is correlated to a look up table correlating X to ice fraction, the correlating value for the ice fraction being offset dependent on the determined concentration of antifreeze.

Specific embodiments of the invention will now be described, by way of example only, with reference to the following drawings in which:

### BRIEF DESCRIPTION OF THE DRAWINGS

FIG. 1 is a diagram of the sensing component of the invention adapted to sense the capacitance of the ice slurry;

FIG. 2 is a diagram of the invention as shown in FIG. 1 including a temperature sensor;

FIG. 3 is a diagram of an alternative sensing component of the invention adapted to sense the capacitance of the ice slurry;

FIG. 4 is a diagram of an RC oscillator circuit;

FIG. 5 is a diagram of a sensing circuit to measure the ice fraction of an ice slurry;

FIG. 6 is a diagram of the sensing component of the invention adapted to sense the impedance of the ice slurry; and

FIG. 7 is a diagram of an alternative sensing circuit to measure the ice fraction of an ice slurry.

### DESCRIPTION OF THE PREFERRED EMBODIMENTS

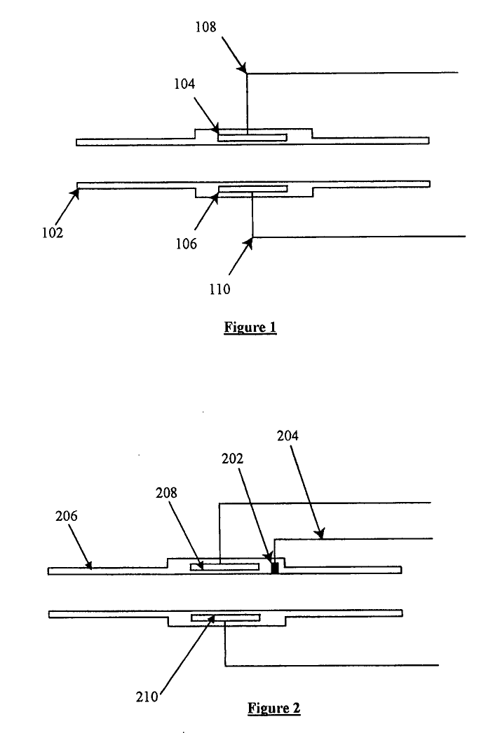

Referring to FIG. 1 an embodiment of the electrical property sensing part 100 of an ice fraction sensor is shown, connectable in line in ice slurry flow to, in use, sense the ice fraction of the slurry passing therethrough by capacitive means. The sensing part comprises body section 102 made of a plastics molding, preferably one with good low temperature characteristics, for example polypropylene. Encapsulated within the body section 102 are electrode plates 104 106, made of electrically conductive materials, in spaced relationship to one another and arranged such that in use the ice slurry passing through the sensing part 100 passes between plates 104 and 106. The plates 104 106 are encapsulated wholly within the body 102 such that the body forms a barrier between the plates 104 106 and the slurry passing therebetween. The body 102 is of an electrically insulating material so as to prevent conduction from one plate to the other via the ice slurry. Electrode plates 104 106 are connected to a sensing circuit by connectors 108 110.

Referring to FIG. 2 the electrical property sensing part of FIG. 1 is shown which in addition has a temperature sensor 202 for detecting the temperature of the ice slurry passing through the sensor. The temperature sensor is connected to the sensing circuit by means of electrical connection 204 to carry a signal, indicative of the temperature of the ice slurry passing therethrough, to the sensing circuit. The sensor may be directly in contact with the fluid as shown in the Figure or may be isolated therefrom by the body section 206 in the same manner as are the plates 208 210 to protect the temperature sensor from the ice slurry.

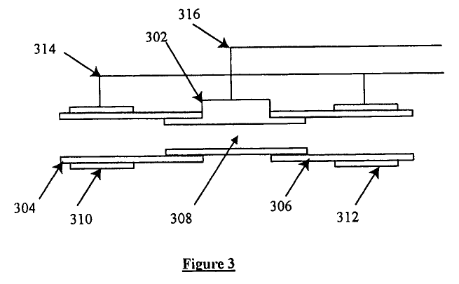

Referring to FIG. 3 the electrical property sensing part an alternative arrangement of the sensing part shown in FIG. 1 also adapted, in use, to sense the ice fraction of the slurry passing therethrough by capacitive means, is shown. The sensing part 300 comprises an electrically conductive joining element 302 having a central bore therethrough for joining two sections of tube 304, 306 such that an ice slurry can pass from one tube to the other via the central bore 308 of the joining element such that said ice slurry passing through the central bore 308 comes into electrical contact therewith. Surrounding both of the tubes 304, 306, sufficiently spaced from the ends thereof such that when assembled onto the joining element 302 there is no overlap therewith, is an electrically conductive collar 310, 312. The collars 310 are insulated from electrical contact with the ice slurry by means of the tube 304, 306 walls and are together connected to an electrical sensing circuit by connector 314. The joining element 302 is connected to the same sensor circuit by connector 316 such that the joining element 302 and the two collars 310, 312 form electrodes of a capacitor. The sensing part 300 may also include a temperature sensor as described in relation to FIG. 2 for sensing the temperature of the ice slurry passing therethrough.

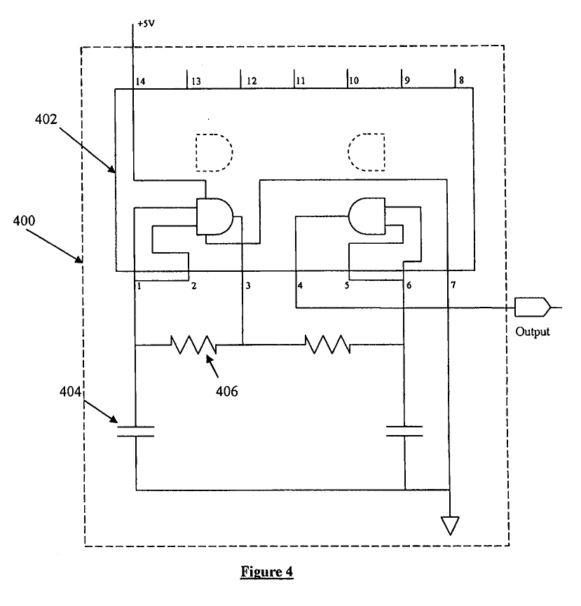

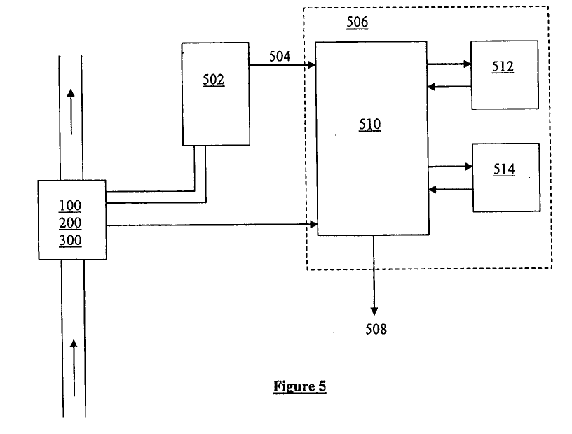

In use, the sensing part as described in reference to FIGS. 1 to 3 is used as the capacitor 404 of an RC oscillator circuit shown in FIG. 4 comprising an oscillator chip 402 (which could be for example a CD74HC132 chip from “Texas Instruments”), a capacitor 404 and a resistor 406. Referring to FIG. 5, the changing capacity of the sensing part 100, 200, 300 as the ice fraction of the slurry passing therethrough varies, results in a change in the output frequency of the RC oscillator circuit 502 (as shown in FIG. 4). The output 504 of the oscillator circuit 502 is inputted into a controller 506 which outputs a varying electrical signal 508 of 4-20 mA, the magnitude of output signal directly indicative of the ice fraction. The controller 506 includes a processor 510 and a first look up table 512 which contains data correlating the frequency of the oscillator to the ice fraction of the slurry. Where a temperature sensor is included in the sensing part 100, 200, 300, the controller 506 monitors the temperature and detects the temperature at which ice formation begins. This temperature can then be used in association with a second look up table 514 to detect an offset, related to the to concentration of a freezing point suppressant in the ice slurry, the offset being used to offset either the frequency of the oscillator prior to inputting it to the lookup table, or alternatively to offset the output from the lookup table, or a processed signal dependant thereon to compensate the outputted ice fraction for varying concentrations freezing point suppressant within the ice slurry.

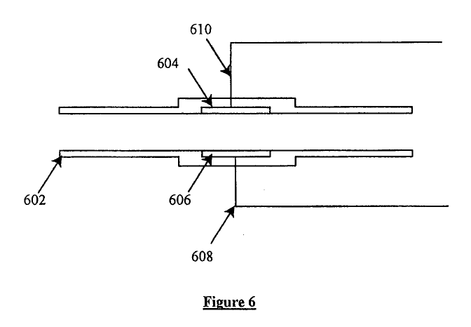

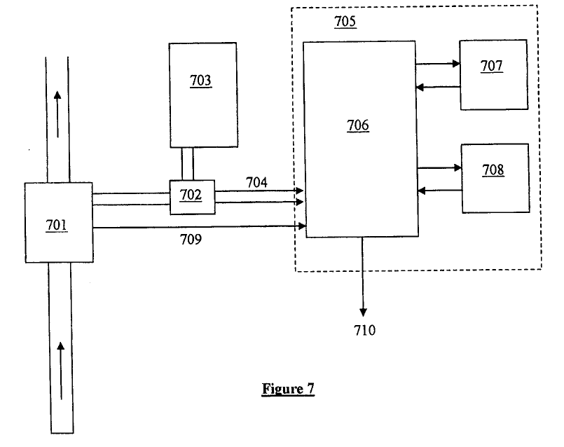

Referring to FIG. 6 an embodiment of the sensing part 600 of an ice fraction sensor is shown, connectable in line in ice slurry flow to sense the ice fraction of the slurry passing therethrough by inductive means. The sensing part comprising a body section 602 made of a plastics moulding, preferably one with good low temperature characteristics, for example polypropylene. Encapsulated within the body section 602 are two electrically conductive plates 604, 606 forming electrodes in spaced relationship to one another and arranged such that they are in electrical contact with the ice slurry passing therebetween thereby using the impedance of the sensing part to influence an electrical circuit as shown in FIG. 5 by means of electrical connection 608, 610 therewith. The sensing part of this arrangement is used to replace the resistor 406 of the RC oscillator of FIG. 4. The oscillating output signal from the RC oscillator is processed by a controller, in the same way as described in reference to FIG. 5, to generate an output signal indicative of the ice fraction.

Referring to FIG. 7 sensing part 701 of an ice fraction sensor has a pair of electrodes and a temperature sensor. A sinusoidal wave generator 703 supplies an oscillating signal to the sensing part 701 and a impedance analyzer 702 (for example part number AD8302 from Analogue Devices) creates output signals 704 relating to the amplitude and phase of the impedance of the circuit containing the electrodes. A signal processing means 705 includes a microcontroller 706 which receives the signals 704 and performs an algorithm on them to calculate either the conductivity or the reactance of the circuit as described hereinbefore. The microcontroller also receives a signal 709 relating to the temperature of the fluid passing through the sensing part 701.

When the fluid is in its fully liquid state the wave generator 703 creates a low frequency signal of around 1 MHz and the microcontroller calculates the conductivity R of the circuit. The microcontroller 706 then compares the temperature and the conductivity to a look-up table 707 to calculate an offset relating to the percentage antifreeze in the fluid being measured. When the fluid is part ice and part liquid the wave generator 703 creates a high frequency signal in excess of 25 MHz and the microcontroller 706 calculates the conductivity R of the circuit. The microcontroller 706 then compares the conductivity to a look up table 708 and offsets the correlated ice fraction by the offset calculated when the fluid was in its fully liquid phase to calculate a measured ice fraction of the ice liquid mixture and outputs a signal 710 indicative of the ice fraction.

What is claimed is:

1. A method of method of measuring the ice fraction of an ice slurry comprising the steps of:
a) establishing in the slurry first and second, mutually spaced electrodes;
b) connecting the electrodes into an electrical circuit adapted to sense, across the electrodes the magnitude of an electrical property of the slurry that varies with the ice fraction thereof, said circuit being adapted to generate an output signal indicative, in response to the sensed magnitude of said electrical property, of the ice fraction of the slurry; and
c) energising the electric circuit, whereby said output signal is generated.

2. The method according to claim 1 further comprising the step of comparing the output signal to a first look up table containing data relating the received signal to the percentage ice fraction of the slurry.

3. The method according to claim 1 further comprising the step of performing a predictive algorithm on the output signal to calculate the percentage ice fraction of the slurry.

4. The method according to claim 1 wherein at least one of said first and second electrodes is electrically insulated from the ice slurry and the output signal is purely dependant on the capacitance across the two electrodes

5. The method according to claim 1 wherein the first and second electrodes are in electrical contact with the ice slurry and the output signal is dependant on both the capacitance and the conductivity across the two electrodes.

6. The method according to claim 1 wherein the first and second electrodes are in electrical contact with the ice slurry and the output signal is dependant on the impedance of the ice slurry between the two electrodes.

7. The method according to claim 4 wherein the electrodes form a capacitor of an RC oscillator such that the change in capacitance across the electrodes due to the change in ice fraction of the slurry between the electrodes changes the frequency of the output signal of the RC oscillator.

8. The method according to claim 5 wherein the electrodes and the ice slurry therebetween form a resistor of an RC oscillator such that the change in conductivity or impedance due to the change in ice fraction of the slurry between the electrodes changes the frequency of the output signal of the oscillator.

9. The method according to claim 7 wherein the RC oscillator is an RC Schmitt-Trigger oscillator.

10. The method according to claim 9 wherein the resistor of the RC oscillator is selected to give an output frequency from the oscillator from 0.8 to 1.2 MHz

11. The method according to claim 6 wherein the electrodes form part of an electric circuit which also comprises a sinusoidal wave generator and an impedance analyzer.

12. The method according to claim 11 further comprising signal processing means to calculate reactance X, or conductivity R, of the electric circuit.

13. The method according to claim 12 wherein the calculated value of X, or R, is compared to a first look up table containing data to correlate X, or R, to the percentage ice fraction of the slurry.

14. The method according to claim 12 wherein a microcontroller performs a predictive algorithm on the output signal to calculate the percentage ice fraction of the slurry.

15. The method according to claim 1 further comprising the steps of:
during the initial creation of the slurry, monitoring the temperature of the liquid as it cools,
identifying the temperature at which ice formation starts; and
using this temperature to generate an offset to compensate for effects of freezing point suppression within the liquid prior to freezing.

16. The method according to claim 15 wherein the offset is generated by comparing the temperature at which ice formation starts to a lookup table of offset values.

17. The method according to claim 15 wherein the offset is used to adjust the values in a further lookup table containing data to correlate reactance X, or conductivity R, to the percentage ice fraction of the slurry prior to creating the signal indicative of the percentage ice fraction of the ice slurry.

18. A method of controlling an ice slurry generator having a cooling circuit comprising the steps of:
sensing if the ice fraction rises above or falls below respective set points by measuring the output frequency of an RC oscillator, the capacitor of which comprises two electrodes separated, in use, by a liquid or an ice slurry;
when the output frequency of the oscillator rises above a set value, turning the cooling circuit off; and
when the output frequency of the oscillator falls below a set value turning the cooling circuit on.

19. A method of controlling an ice slurry generator having a cooling circuit comprising the steps of:
sensing if the ice fraction rises above or falls below respective set points by measuring the output frequency of an RC oscillator, the resistor of which comprises two electrodes separated, in use,
by a liquid or an ice slurry;
when the output frequency of the oscillator rises above a set value, turning the cooling circuit off; and
when the output frequency of the oscillator falls below a set value turning the cooling circuit on.

20. An ice slurry sensor comprising an RC oscillator, the capacitor of which comprises two electrodes separated, in use, by a liquid or a liquid/ice mixture, configured to output a signal the frequency of which is indicative of the ice fraction of the ice slurry.
